(19) United States
(12) Patent Application Publication
(10) Pub. No.: US 2021/0043178 A1
(43) Pub. Date: Feb. 11, 2021

(54) CYMBAL PICKUP APPARATUS

(71) Applicant: Roland Meinl Musikinstrumente GmbH & Co. KG, Gutenstetten (DE)

(72) Inventor: Michael BUCHNER, Kelkheim (DE)

(21) Appl. No.: 16/984,864

(22) Filed: Aug. 4, 2020

(30) Foreign Application Priority Data
Aug. 8, 2019 (DE) 20 2019 104 371.7

(51) Int. Cl. G10H 3/14; G10D 13/063; G10H 1/46

(52) U.S. Cl. CPC G10H 3/143; G10H 2220/525; G10H 1/46; G10D 13/063

(57) ABSTRACT

A cymbal pickup apparatus comprises a housing, a contact wall on the housing, by means of which the pickup apparatus is adapted to be brought into mechanical and sound-transmitting contact with the cymbal, a sound transducer on an inner side of the contact wall for converting a sound signal picked up from the cymbal into an electrical signal representative of the cymbal sound, an electrical connection device on the housing for transmitting the electrical signal, and a signal cable for the electrical signal, wherein the signal cable is detachably connectable to the electrical connection device.

### CROSS-REFERENCE TO RELATED APPLICATIONS

This application claims the priority of Germany Utility Model Application, Serial No. 20 2019 104 371.7, filed Aug. 8, 2019, the content of which is incorporated herein by reference in its entirety as if filly set forth herein.

### FIELD OF THE INVENTION

The invention relates to a cymbal pickup apparatus used for faithful pickup of the tone of a traditional cymbal.

### BACKGROUND OF THE INVENTION

Normally, the sound of a drum kit, in particular at large concerts, is picked up by means of microphones and electrically amplified. The problem is that the individual microphones capture not just one but rather usually multiple sound sources at different levels, which means that accurate mixing of the drum sound, in particular across the different types of cymbals, is difficult in practice.

The prior art, such as for example EP 3 428 912 A1, discloses electric cymbal apparatuses in which an impact-sensitive area is coupled to a piezo sensor that captures the impact of a drumstick on the striking surface and triggers the generation of a synthetic cymbal sound from an appropriate tone generation unit. This has nothing to do with the capture and forwarding of a natural cymbal tone.

U.S. Pat. No. 5,134,920 discloses the use of a piezoelectric device in combination with a drum skin, wherein the vibration of the drum skin is captured and a corresponding electrical signal is forwarded to a preamplifier.

The invention is thus based on an object of providing a cymbal pickup apparatus by means of which the natural tone of a cymbal can be picked up directly without using a microphone and converted into an electrical signal representative of the cymbal sound.

This object is achieved by a cymbal pickup apparatus having the following characterizing features:
a housing,
a contact wall on the housing, by means of which the pickup apparatus is adapted to be brought into mechanical and sound-transmitting contact with the cymbal,
a sound transducer on the inner side of the contact wall for converting a sound signal picked up from the cymbal into an electrical signal representative of the cymbal sound,
an electrical connection device on the housing for transmitting the electrical signal, and
a signal cable for the electrical signal, wherein the signal cable is detachably connectable to the electrical connection device.

The pickup apparatus according to the invention has, despite its simplicity, been found to be particularly well suited to direct pickup of the cymbal tone with conversion into an electrical signal, so that it is possible to move away from the standard microphones for electrically amplifying the cymbal tone. The pickup apparatus is realizable in such small and compact fashion that attaching it to the cymbal, preferably by means of an adhesive layer on the contact wall, does not lead to a noticeable change of tone. Furthermore, the detachable connection of the signal cable means that the latter can be taken off and the actual pickup apparatus can remain permanently mounted on the cymbal. On a tour, for example, it is therefore no problem to pack the cymbals in appropriate cases without cable tangle, to dismantle them and set them up and accordingly to easily cable them after setup for a concert.

As such, the sound transducer is preferably a piezoelectric sound transducer, as is fundamentally already known per se for picking up a trigger signal from percussion instruments. In the present case, however, no such trigger signal, but rather an electrical signal representative of the cymbal sound, is generated by the sound transducer.

In order to mechanically decouple the sound transducers from the connection device, there is provision for an internal cable in the housing.

According to a further preferred embodiment, the contact wall and the housing are in the form of electrically connected, for example by soldering, metal parts that can therefore act as the earth terminal of the pickup apparatus.

A particularly clever embodiment of the connection device in terms of use is that it is in the form of a magnetic coupling to the signal cable. The latter can therefore easily be removed by overcoming the usual magnetic force between the coupling parts, which is high at short intervals, but reliably holds onto the connection device during playing precisely by virtue of this high magnetic force.

An embodiment of this connection device that is advantageous in terms of design provides for an annular magnetic earth contact, which is electrically connected to the housing, and a central, preferably pin-shaped, magnetic signal contact connected to the sound transducer and if necessary to the internal cable.

Good reproducibility of the cymbal sound by means of the pickup apparatus according to the invention is promoted by virtue of the housing being in the form of a domed hollow shell, the open side of which is sealed by the contact wall that has the sound transducer on the inner side.

Finally, the signal cable may be provided with a volume control for the electrical signal. This allows the percussionist to vary the volume of each individual cymbal individually, irrespective of the main gain at the mixing desk, and therefore to himself contribute to the balance of the drum sound.

Further features, details and advantages of the invention will emerge from the description of an exemplary embodiment below on the basis of the accompanying drawings.

### BRIEF DESCRIPTION OF THE DRAWINGS

FIG. 1 shows a schematic sectional view of a cymbal with a pickup apparatus,

FIG. 2 shows a partial sectional view of the pickup apparatus,

FIG. 3 shows a plan view of the pickup apparatus shown in FIG. 2,

FIG. 4 shows a signal cable of the pickup apparatus, and

FIG. 5 shows a schematic diagram of the circuit in the pickup and volume control of the signal cable shown in FIG. 4.

### DESCRIPTION OF THE PREFERRED EMBODIMENT

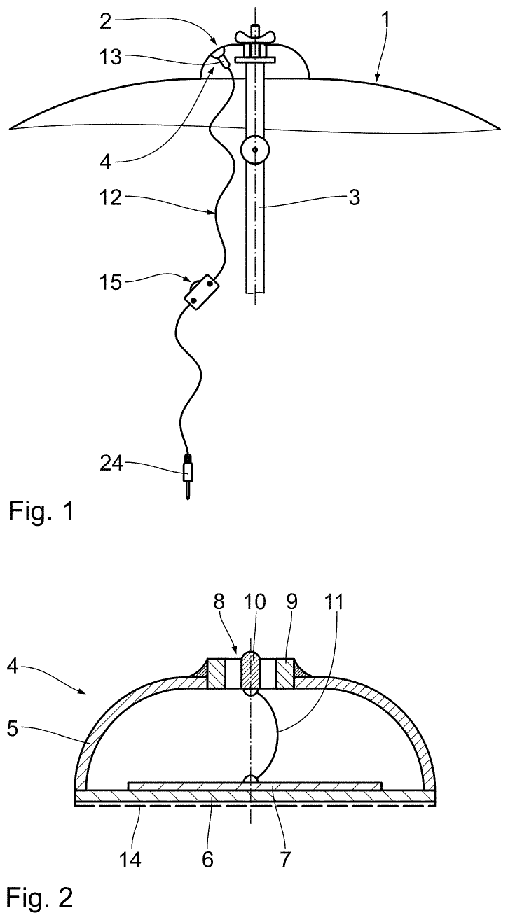

FIG. 1 depicts a standard cymbal 1 suspended by its cymbal bell 2 on a stand 3. Attached to the underside of the cymbal bell 2 in a manner yet to be explained in more detail is the pickup apparatus, denoted as a whole by 4. Said pickup apparatus, as is evident from FIG. 2, in particular, has a copper or brass housing 5 in the form of a domed hollow shell, the open side of Which housing is sealed by a plate-shaped contact wall 6 made from sheet brass. Positioned on the inner side of the contact wall 6 is a sound transducer 7 in the form of a piezo crystal part, which normally converts the acoustic vibrations of the cymbal 1 that are transmitted to the sound transducer 7 via the contact wall 6 into an electrical signal representative of the cymbal sound.

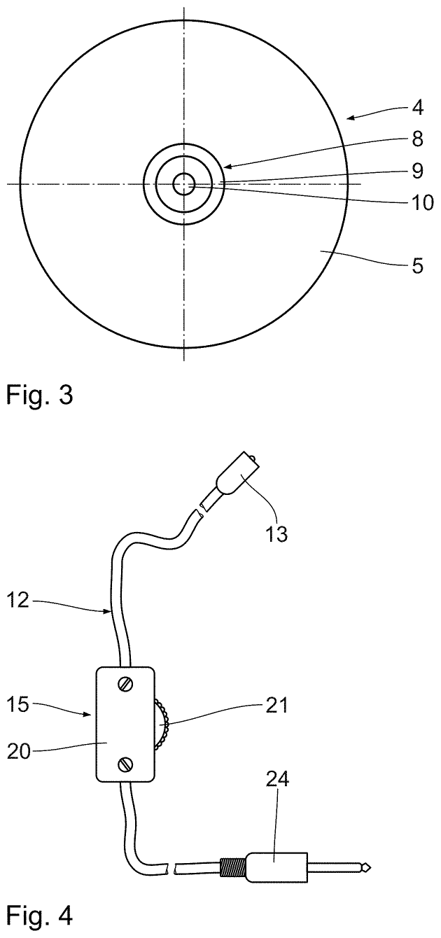

As becomes clear from FIGS. 2 and 3, on the side of the housing 5 that is opposite the contact wall 6 there is, arranged centrally in an appropriate opening, an electrical connection device 8 that has an outer, annular earth contact 9 and a central, pin-shaped signal contact 10. The latter is connected to the sound transducer 7 via an internal cable 11, so that the electrical signal from said sound transducer, which is representative of the cymbal sound, is able to be tapped off from the signal contact 10.

Both the earth contact 9 and the signal contact 10 are produced from a permanent magnetic material, so that a signal cable 12 having a magnetic coupling 13 can be detachably mounted on the connection device 8 by means of the magnetic adhesive force. Said force is indeed large enough for the magnetic coupling 13 to be reliably fixed to the connection device 8 during normal playing, and thus for there to be reliably no possibility of the signal cable 12 falling off the housing 5 and thus a signal being interrupted. However, the adhesive force is also limited such that, when the magnetic coupling 13 is removed from the connection device 8, an adhesive bond between the housing 5 and the cymbal 1 in the form of the adhesive layer 14, indicated by dashes in FIG. 2, on the outer side of the contact wall 6 is not impaired and hence permanent fixing of the housing 5 to the cymbal 1 is ensured.

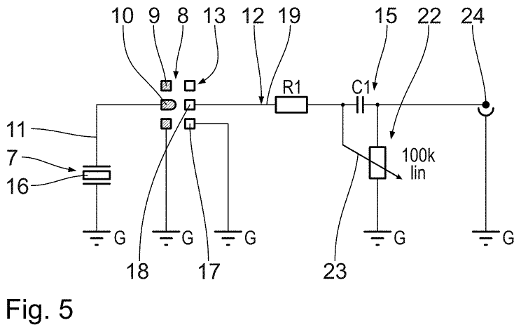

As is evident from FIG. 4, the signal cable 12 incorporates a volume control 15, the circuit of which is depicted schematically in FIG. 5 together with the actual measuring transducer circuit. The latter has the sound transducer 7 in the form of the piezo crystal 16, which is connected, in terms of circuitry, as a capacitance between earth G and the internal cable 11. The internal cable 11 is connected to the signal contact 10 of the connection device 8, the earth contact 9 of which is likewise connected to earth G. The magnetic coupling 13 on the signal cable 12 has, in accordance with the earth contact 9 and the signal contact 10 of the connection device 8, an annular earth contact 17, which is connected to earth G, and a jack-shaped signal contact 18 that matches the pin-shaped signal contact 10. Said jack-shaped signal contact supplies the electrical signal via the line 19 in the signal cable 12 to the circuit, shown in FIG. 5, of the volume control 5 depicted in FIGS. 1 and 4. Said volume control has a housing 20 having a knurled wheel 21, mounted rotatably therein and protruding on one side, which is used to operate a potentiometer 22 in the circuit shown in FIG. 5. Said potentiometer has an R-C series element having a resistor R1 and a capacitance C1 connected in series therewith, between which the control tap 23 of the potentiometer 22 is connected.

Arranged at the end of the signal cable 12 that is remote from the magnetic coupling 13 is a standard jack plug 24 for supplying the electrical signal to an amplifier or a mixing desk.

What is claimed is

1. A cymbal pickup apparatus, comprising
a housing,
a contact wall on the housing, by means of which the pickup apparatus is adapted to be brought into mechanical and sound-transmitting contact with the cymbal,
a sound transducer on an inner side of the contact wall for converting a sound signal picked up from the cymbal into an electrical signal representative of the cymbal sound,
an electrical connection device on the housing for transmitting the electrical signal, and
a signal cable for the electrical signal, wherein the signal cable is detachably connectable to the electrical connection device.

2. The pickup apparatus according to claim 1, comprising an adhesive layer on the contact wall for adhesively bonding the pickup apparatus to the cymbal.

3. The pickup apparatus according to claim 1, wherein the sound transducer is a piezoelectric sound transducer.

4. The pickup apparatus according to claim 1, wherein the sound transducer is connected to the connection device by means of an internal cable.

5. The pickup apparatus according to claim 1, wherein the contact wall and the housing are in the form of electrically connected metal parts and form the earth terminal of the pickup apparatus.

6. The pickup apparatus according to claim 1, wherein the connection device is in magnetic form for the purpose of detachably connecting the signal cable provided with a magnetic coupling.

7. The pickup apparatus according to claim 6, wherein the connection device has an annular magnetic earth contact, which is electrically connected to the housing, and a central magnetic signal contact connected to the sound transducer and if necessary to the internal cable.

8. The pickup apparatus according to claim 7, wherein the magnetic signal contact is pin-shaped.

9. The pickup apparatus according to claim 1, wherein the housing is in the form of a domed hollow shell, the open side of which is sealed by the contact wall.

10. The pickup apparatus according to claim 1, wherein the signal cable incorporates a volume control for the electrical signal.

11. The pickup apparatus according to claim 1, comprising attachment to the cymbal bell of a cymbal.
